(19) United States
(12) Patent Application Publication
(10) Pub. No.: US 2011/0202312 A1
(43) Pub. Date: Aug. 18, 2011

(54) OPERATION SOUND COLLECTION SYSTEM AND METHOD

(76) Inventors: Katsuhiro SUMI, Hino-shi (JP); Takahiro Shirota, Fuchu-shi (JP); Hiroyuki Kobayashi, Matsudo-shi (JP); Tomohiko Tanimoto, Tama-shi (JP); Kimito Idemori, Saitama-shi (JP); Nobutaka Nishimura, Koganei-shi (JP)

(21) Appl. No.: 13/014,816

(22) Filed: Jan. 27, 2011

(30) Foreign Application Priority Data
Feb. 16, 2010 (JP) 2010-031819

(51) Int. Cl. G06F 15/00; G01N 29/14

(52) U.S. Cl. 702/182

(57) ABSTRACT

According to one embodiment, a system includes a first operation sound collector, a second operation sound collector, a database, a receiver, and controller. The first operation sound collector is provided in a movable part of equipment, and transmits first data including inclination angle data and first operation sound data. The second operation sound collector is provided in a fixed part of the equipment, and transmits second data including second operation sound data being collected simultaneously with the first operation sound data. The database stores operation sound data in normal operation. The receiver simultaneously receives the first data and the second data. The controller determines whether an operation sound is abnormal based on the first data, the second data, and the operation sound data of the database.

### CROSS-REFERENCE TO RELATED APPLICATIONS

This application is based upon and claims the benefit of priority from Japanese Patent Application No. 2010-031819, filed Feb. 16, 2010; the entire contents of which are incorporated herein by reference.

### FIELD

Embodiments described herein relate generally to an operation sound collection system and method, which collect operation sounds of a plant, and diagnose a fault.

### BACKGROUND

A monitoring system is used for monitoring a fault in a plant including a movable part. A monitoring system collects operation sounds of equipment such as a plant, compares the collected operation sounds with normal operation sounds previously stored in a database, and diagnoses the fault of the equipment.

### BRIEF DESCRIPTION OF THE DRAWINGS

FIG. 1 is a block diagram of an example of an operation sound collection system according to an embodiment;

FIG. 2 is a block diagram of an example of a configuration of a repeater of an operation sound collection system according to the embodiment;

FIG. 3 is a block diagram of an example of a configuration of an operation sound collector of the operation sound collection system according to the embodiment;

FIG. 4 shows a sequence of an example of a method of periodically collecting operation sounds (collecting operation sounds at fixed times) executed by the operation sound collection system according to the embodiment;

FIG. 5 shows a sequence of an example of a method of collecting operation sounds at optional timing based on an operation sound data collection command, executed by the operation sound collection system according to the embodiment;

FIG. 6 is a block diagram of a first example of the operation sound collection system configured to send delimiter data from an operation sound collector to a repeater in the embodiment;

FIG. 7 is a block diagram of a second example of the operation sound collection system configured to send the delimiter data from the operation sound collector to the repeater in the embodiment;

FIG. 8 is a graph showing a first example of generating the delimiter data by using an inclination sensor of the operation sound collection system according to the embodiment;

FIG. 9 is a diagram showing a first movement state

A of an elevator movable part of the operation sound collection system according to the embodiment;

FIG. 10 is a diagram showing a second movement state B of the elevator movable part of the operation sound collection system according to the embodiment;

FIG. 11 is a diagram showing a third movement state C of the elevator movable part of the operation sound collection system according to the embodiment;

FIG. 12 is a diagram showing a fourth movement state D of the elevator movable part of the operation sound collection system according to the embodiment;

FIG. 13 is a graph showing a second example of generating the delimiter data by using the inclination sensor of the operation sound collection system according to the embodiment;

FIG. 14 is a diagram showing a fifth movement state E of the elevator movable part of the operation sound collection system according to the embodiment;

FIG. 15 is a diagram showing a sixth movement state F of the elevator movable part of the operation sound collection system according to the embodiment;

FIG. 16 is a diagram showing a seventh movement state G of the elevator movable part of the operation sound collection system according to the embodiment;

FIG. 17 is a diagram showing an eighth movement state H of the elevator movable part of the operation sound collection system according to the embodiment; and

FIG. 18 is a diagram showing exemplary positions to collect elevator operation sounds of the operation sound collection system according to the embodiment.

### DETAILED DESCRIPTION

In general, according to one embodiment, an operation sound collection system collects operation sounds of equipment. The operation sound collection system comprises a first operation sound collector, a second operation sound collector, a database, a receiver, and a controller.

The first operation sound collector is provided in a movable part of the equipment, provided with a first inclination sensor, collects first operation sound data of the movable part, and transmits first data which associates the first operation sound data with first inclination angle data of the movable part or delimiter data indicating a specific position determined based on the first inclination angle data.

The second operation sound collector is provided in a fixed part of the equipment, collects second operation sound data of the fixed part simultaneously with collection by the first operation sound collector, and transmits second data including the second operation sound data.

The database stores operation sound data in normal operation.

The receiver simultaneously receives the first data transmitted from the first operation sound collector and the second data transmitted from the second operation sound collector.

The controller determines a first position at which the first operation sound data is collected, based on the first inclination angle data or delimiter data received by the receiver, compares the first operation sound data corresponding to the first position, and the second operation sound data corresponding to a second position indicating the fixed part in which the second operation sound data is collected, with the operation sound data in normal operation stored in the database, and determines whether an operation sound is abnormal.

An embodiment will be explained below with reference to accompanying drawings.

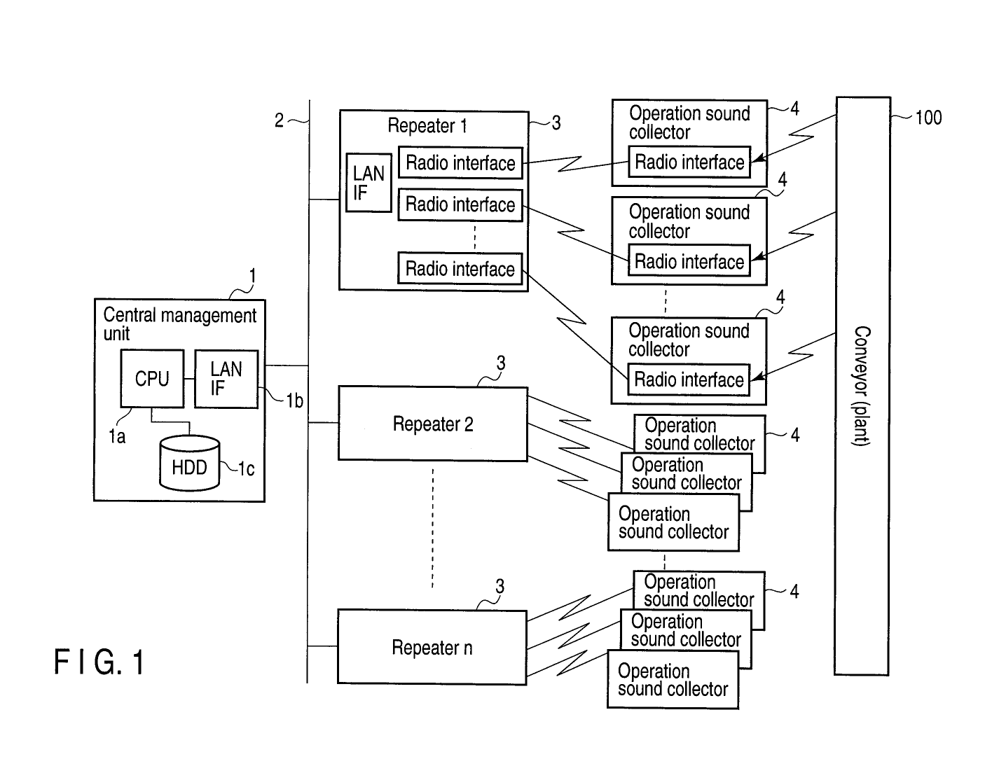

FIG. 1 is a block diagram of an example of an operation sound collection system according to an embodiment.

As shown in FIG. 1, an operation sound collection system comprises a central management unit 1, a local area network (LAN) 2, repeaters (1-n) 3, and operation sound collectors 4.

The central management unit 1 includes a central processing unit (CPU) 1a, a local area network interface (LAN IF) 1b, and a hard disk drive (HDD) 1c. The CPU 1a is a control device to control the central management unit 1. The CPU 1a sends command data, such as an operation sound collection request, to the repeaters 3 through the LAN interface 1b and LAN 2.

The CPU 1a compares received data with data stored in the HDD 1c, and analyzes the data (diagnoses a fault).

The LAN interface 1b is an interface for connecting the repeaters 3 through the LAN 2.

The HDD 1c stores various data including, for example, operation sound data of a conveyor 100 (plant or elevator) received (entered) from the repeater, inclination (tilt) angle data corresponding to the operation sound data (described later), normal operation sound data of the conveyor 100, and inclination angle data corresponding to the normal operation sound data. The HDD 1c is, for example, a database.

The repeater 3 receives a radio signal including operation sound data of the conveyor 100 collected by a plurality of operation sound collectors 4. Two or more repeaters 3 may be provided. The repeaters 3 simultaneously receive radio signals from the operation sound collectors 4 being set. Therefore, each repeater 3 has a plurality of radio interfaces, and simultaneously receives radio signals including operation sound data of the conveyor 100 from the operation sound collectors 4 through the radio interfaces.

The operation sound collectors 4 are provided at respective locations in the conveyor 100. The operation sound collectors 4 are provided in movable and fixed parts of the conveyor 100. The operation sound collectors 4 provided in the movable and fixed parts of the conveyor 100 simultaneously collect operation data. Each operation sound collector 4 is paired with each repeater 3, and set for radio connection. Radio communication is possible between paired units.

Command data such as an operation sound collection request from the central management unit 1 is sent to the repeaters 3 provided in the operation sound collection system through the LAN 2.

Based on the received command data, the repeater 3 establishes radio connection, and sends command data to an object (management target) operation sound collector 4.

The operation sound collector 4 operates based on the command data, and returns a radio signal indicating an operation result to the repeater 3. The operation result includes collected operation sound data, for example.

The repeater 3 sends a radio signal received from the operation sound collector 4 to the central management unit 1 once a day, for example, through the LAN 2. The operation sound data collected by the repeater 3 is temporarily stored in the repeater 3.

The central management unit 1 makes display based on the received operation sound data. The central management unit 1 stores, and analyzes the received operation sound data. The collected operation sound data and another data are stored in the HDD 1c as the secondary storage of the central management unit 1.

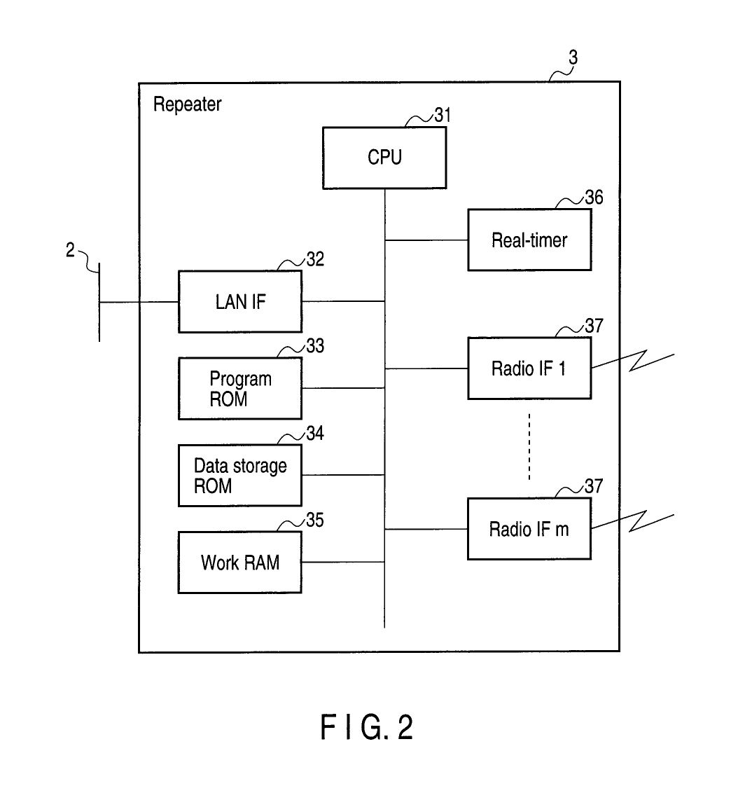

FIG. 2 is a block diagram of an example of a configuration of the repeater 3. The repeater 3 includes a CPU 31, a LAN interface 32, a program ROM (Read-Only Memory) 33, a data storage ROM 34, a work RAM (Random Access Memory) 35, a real-timer 36, and a radio interface 37.

The CPU 31 is a control device operated according to a program stored in the program ROM 33.

The program ROM 33 stores a program, which is executed according to a command data received from the central management unit 1.

The data storage ROM 34 stores operation sound data received from each operation sound collector 4. The work RAM 35 is a work memory area to temporarily store operation sound data received from each operation sound collector 4.

A real-timer 36 is a timer module to set a value of time data included in the command data from the central management unit 1.

The CPU 31 operates based on the command data received from the central management unit 1 through the LAN interface 32. When the command data is a time setting command, for example, the CPU 31 sets the value of time data included in the command data in the internal real-timer 36. The CPU 31 simultaneously sends the time setting command to the object operation sound collectors 4 through the radio interfaces 37 included in the repeater 3. The CPU 31 receives a setting complete notice from each operation sound collectors 4 through each radio interface 37, and informs the central management unit 1 of end of setting through the LAN interface 32.

The CPU 31 receives various data such as operation sound data from the operation sound collector 4 through the radio interface 37, and temporarily stores the data in the work RAM 35.

The CPU 31 stores the data of the work RAM 35 in the data storage ROM 34 by associating with delimiter data, by using the delimiter data received simultaneously with the data from the operation sound collector 4.

After storage processing, the CPU 31 informs the central management unit 1 of the end of collection through the LAN interface 32.

Thereafter, the central management unit 1 sends a data sending command to the repeater 3, and receives necessary operation sound data stored in the storage ROM 34 of the repeater 3 from the repeater 3.

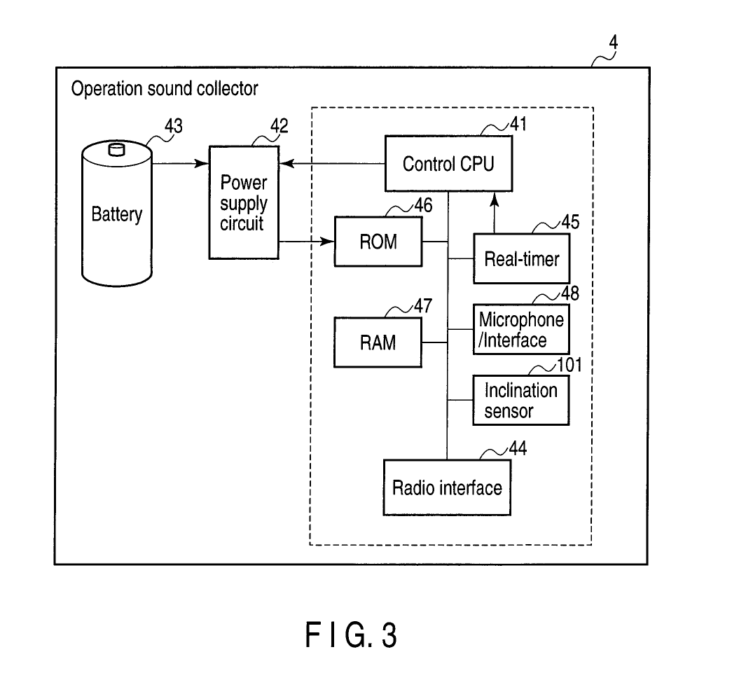

FIG. 3 is a block diagram of an example of an internal configuration of the operation sound collector 4. The operation sound collector 4 includes a control CPU 41, a power supply circuit 42, a battery 43, a radio interface 44, a real-timer 45, a ROM 46, a RAM 47, a microphone/interface 48, and an inclination (tilt) sensor 101.

The control CPU 41 is a control device operated according to a control program stored in the ROM 46. The control CPU 41 is operated according to an operation command received through the radio interface 44.

The power supply circuit 42 receives electromotive force from the battery 43, and controls power supply to components of the operation sound collector 4. The battery 43 is a storage device to store electromotive force. The operation sound collector 4 may be provided in a movable part (e.g. a step) of the conveyor 100, and needs the battery 43 for independent operation.

The radio interface 44 is a radio device for sending a radio signal including collected operation sound data of the conveyor 100 to the repeater 3. The operation sound collector 4 may be provided in the movable part of the conveyor 100, and collected operation sound data is desirably sent by radio.

The real-timer 45 is a timer module to set a start time of the control CPU 41 and so forth. By using the real-timer 45, collection of operation sound data can be accurately started.

The ROM 46 stores a control program to be executed under the control of the control CPU 41.

The RAM 47 is a memory device used to temporarily store. The RAM 47 stores a control program read out from the ROM 46 and so forth.

The microphone/interface 48 is a sound collection device to collect the operation sound data of the conveyor 100. The microphone/interface 48 includes an interface device to output collected operation sound data. The microphone/interface 48 may be provided in either movable or fixed part of the conveyor 100.

The inclination sensor 101 detects inclination of a place where the microphone/interface 48 is provided. When the microphone/interface 48 is provided in the movable part of the conveyor 100, the inclination sensor 101 can detect the inclination of the microphone/interface 48.

The control CPU 41 operates based on the control program stored in the ROM 46. The control CPU 41 operates according to an operation command received from the repeater 3 through the radio interface 44. When the operation command is the time setting command, for example, the control CPU 41 sets a time in the real-timer 45 based on the time setting command. Thereafter, the control CPU 41 sends a time setting complete notice to the repeater 3 through the radio interface 44 (as described later).

The control CPU 41 periodically sets a start time in the real-timer 45. After the setting, the control CPU 41 sends a low power consumption output mode command to the power supply circuit 42 to supply the power of the battery 43, and goes into low power consumption operation (mode).

Receiving a low power consumption output mode command, the power supply circuit 42 stops power supply to the radio interface 44, microphone/interface 48, and inclination sensor 101.

The real-timer 45 sends a notice to the control CPU 41 at the time when the preset startup time is reached. Receiving the notice, the control CPU 41 starts, and returns from the low power consumption output mode to normal operation mode.

When the operation sound collection time is reached, the control CPU 41 informs the repeater 3 of start of operation sound collection through the radio interface 44, and performs an operation sound collection operation (process). On the other hand, when an operation sound collection command is received from the repeater 3 through the radio interface 44, the control CPU 41 performs the operation sound collection operation.

During the operation sound collection operation, the control CPU 41 temporarily stores the operation sound data sent from the microphone/interface 48, and the inclination angle data sent from the inclination sensor 101, in the RAM 47, and sends the operation sound data (received sound data) and inclination angle data (or delimiter data (described later) obtained from the inclination angle data) to the repeater 3 through the radio interface 44.

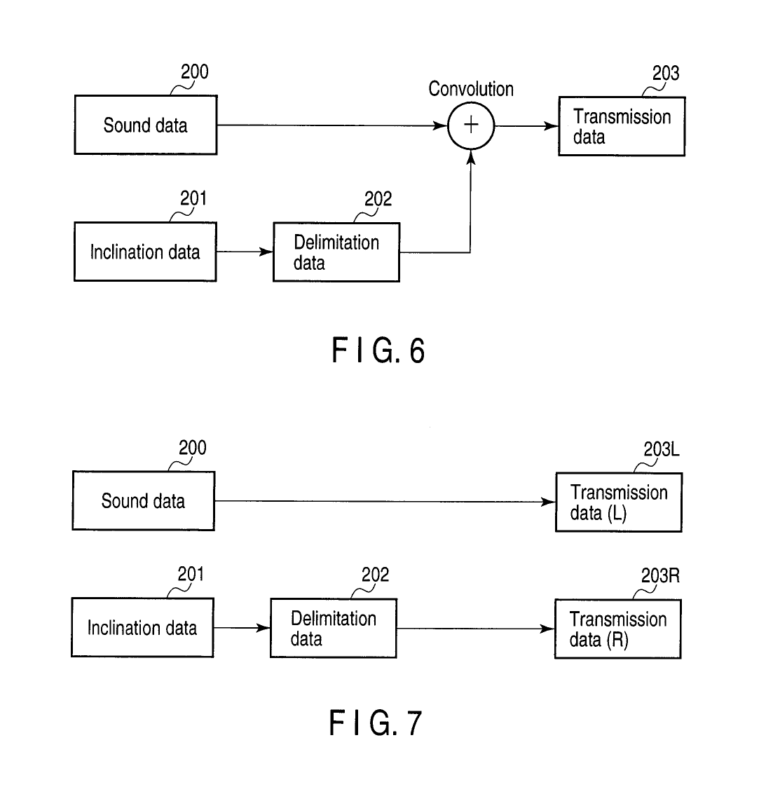

The delimiter data may be sent in being superimposed on the operation sound data, for example (FIG. 6).

The operation sound data and the delimiter data may be sent by being divided into an operation sound data channel and a delimiter data channel. In this case, for example, the inclination angle data may be send as sound data together with the operation sound data (FIG. 7).

A counter of the operation sound collection system counts the number of occurrences of delimiter data obtained from inclination angle data. This enables to grasp the number of cycles of cyclically moving equipment such as a conveyor 100 without age deterioration due to wearing, while decreasing the influence of vibration. In this embodiment, the accuracy of identifying a position of a movable part in which operation sound data is collected and a position of a movable part in which operation sound data is not collected can be increased.

In this embodiment, the operation sound collector 4 may send a radio signal which associates the operation sound data with the inclination angle data to the repeater 3, for example.

Next, the delimiter data will be explained in detail.

When a part of conveyor cyclically moves, for example, the delimiter data indicates any one of the positions where inclination of the movable part changes 90° or more as a delimiter position.

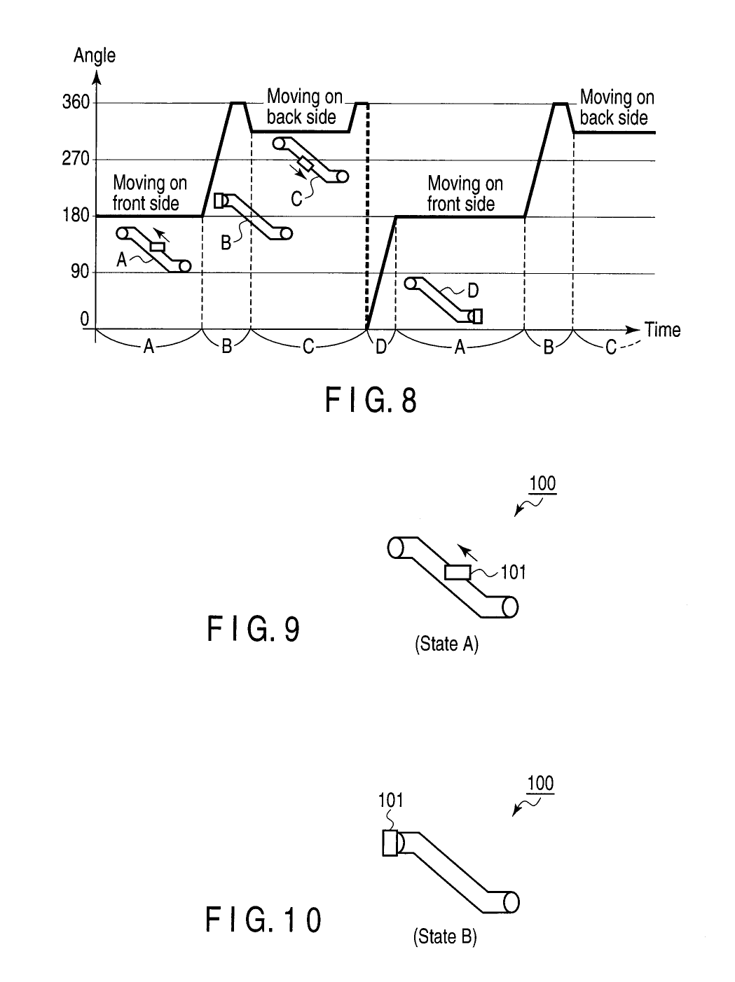

FIG. 8 is a graph diagrammatically showing an example of generating delimiter data by using the inclination sensor 101.

The delimiter data is generated by the inclination sensor 101 fixed to a step (a movable part) of a conveyor 100. In this example, a delimiter is a position to reverse in a lower stage (lower side) of the conveyor 100, and delimiter data is generated at every changing of inclination angle of 90° or more. By counting the delimiter data, the number of cycles can be grasped when inspecting cyclically moving equipment such as a conveyor 100. It is also possible to identify a position in a movable part at which operation sound data is collected. The number of cycles is counted by the operation sound collector 4 or central management unit 1.

For example, in the state A in FIG. 9, the inclination sensor 101 fixed to a step of the conveyor 100 moves from the lower stage (lower side) to an upper stage (upper side). In this state A, an inclination angle obtained by the inclination sensor 101 is 180° (FIG. 8).

Next, in the state B in FIG. 10, the inclination sensor 101 is moved until the upper stage position and reversed. In this state B, as the inclination sensor is reversed, an inclination angle obtained by the inclination sensor 101 is 180 to 360° (FIG. 8).

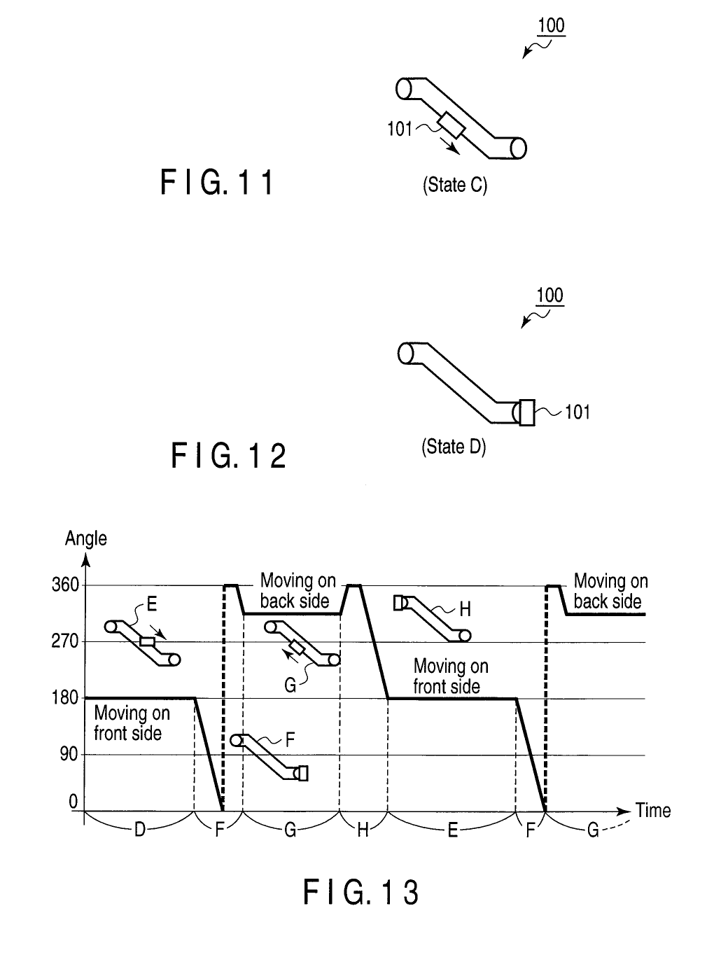

Then, in the state C in FIG. 11, the inclination sensor 101 is reversed and moved from the upper stage to lower stage on the back of the conveyor 100. In this state C, an inclination angle obtained by the inclination sensor 101 is about 330° (FIG. 8).

In the state D in FIG. 12, the inclination sensor 101 is moved down to a lower stage position and reversed. In this state D, as the sensor is reversed, an inclination angle obtained by the inclination sensor 101 is 0 to 360° (FIG. 8).

Thereafter, the step of the conveyor 100 returns to the state A. As described above, the conveyor 100 has a cyclically moving part.

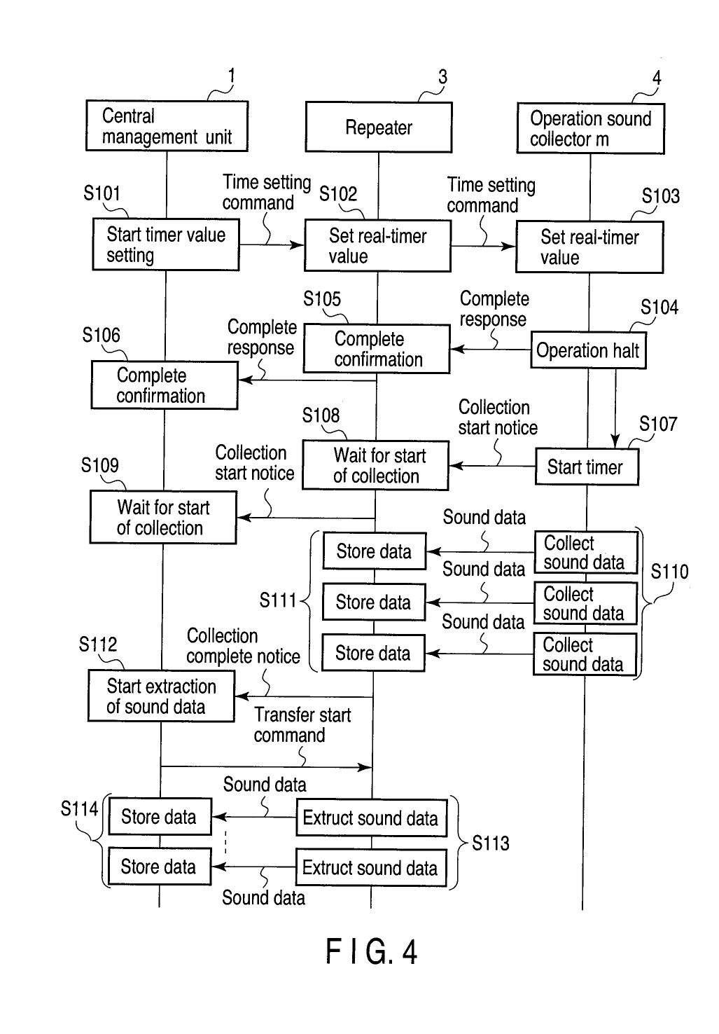

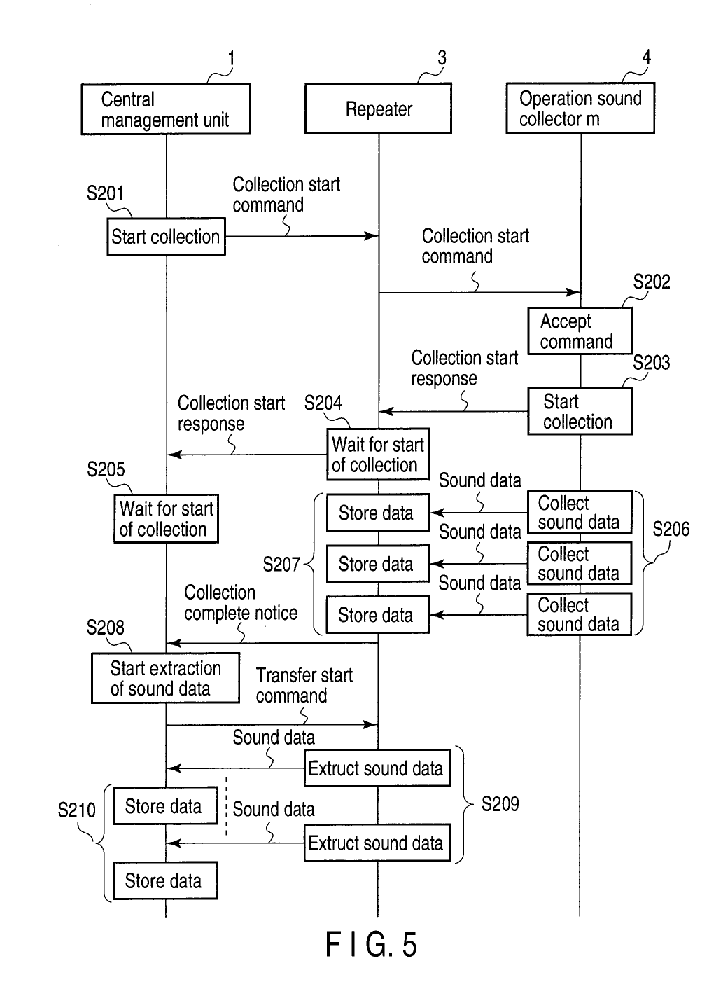

The processes of the embodiment will be explained with reference to the sequences shown in FIGS. 4 and 5.

FIG. 4 shows a sequence of an example of a method of periodically collecting the operation sound (collecting the operation sound at fixed times) executed by the operation sound collection system according to the embodiment.

The central management unit 1 sends command data including a time setting command and so forth to the repeaters 3 provided in the operation sound collection system through the LAN 2, and starts setting of a timer (step S101).

Each repeater 3 establishes radio connection based on a time setting command included in the received command data, executes broadcast of command data including a time setting command to each managed operation sound collector 4, and starts setting of a real-timer (step S102). Each repeater 3 can reduce an error in time synchronization by executing broadcast of the command data including the time setting command to each managed operation sound collector 4.

The CPU 31 of the repeater 3 operates according to the command data including the time setting command received from the central management unit 1 through the LAN interface 32. When the time setting command is included in the command data received from the central management unit 1, the CPU 31 of the repeater 3 sets a value of the received time data in the real-timer 36 of the repeater 3. The CPU 31 of the repeater 3 simultaneously sends the time setting command to the operation sound collectors 4 which are set to be managed by the repeater 3 via the radio interfaces 37 included in the repeater 3.

The control CPU 41 of the operation sound collector 4 operates based on the time setting command received through the radio interface 44. In particular, when the time setting command is included in the command data received from the repeater 3, the CPU 41 of the operation sound collector 4 sets the time data in the real-timer 45 of the operation sound collector 4 (step S103). Thereafter, the control CPU 41 of the operation sound collector 4 sends a time setting complete notice to the repeater 3 through the radio interface 44, and stops collection of the operation sound until a set time, since an operation is started by the real-timer 45 (step S104).

By stopping collection of the operation sound until the set time, power supply to the radio interface 44 and other main components is stopped, and the power consumption of the battery 43 is reduced.

The operation sound collector 4 (for example, periodically) sets a start time of the control CPU 41 in the real-timer 45. After the setting, the operation sound collector 4 sends a low power consumption output mode command to the power supply circuit 42 which supplies the power of the battery 4, and starts low power consumption operation. Receiving the command to shift to low power consumption output mode, the power supply circuit 42 of the operation sound collector 4 stops power supply to the radio interface 44, microphone/interface 48, and inclination sensor 101 and so forth.

After receiving a setting complete notice from each operation sound collector 4 through the radio interface 37, the CPU 31 of the repeater 3 sends a setting complete confirmation (a collection end notice) to the central management unit 1 through the LAN interface 32 (step S105). Receiving the collection complete notice, the central management unit 1 executes a completing confirmation (step S106).

The real-timer 45 of the operation sound collector 4 starts a timer (step S107), and the control CPU 41 notifies the repeater 3 of start of operation sound collection through the radio interface 44. After receiving a notice of the collection sound start, the CPU 31 of the repeater 3 goes into a collection start waiting state (step S108), and sends the notice of the collection sound start to the central management unit 1. After receiving the notice of the collection sound start, the central management unit 1 goes into a collection start waiting state (step S109).

The real-timer 45 of the operation sound collector 4 sends a notice to the control CPU 41 when the set start time is reached. Receiving the notice, the control CPU 41 starts, and returns from the low power consumption output mode to normal operation mode. The control CPU 41 of operation sound collector 4 is executes the operation sound collecting operation (step S110). Each operation sound collecting operation of the operation sound collector 4 simultaneously executes the operation sound collecting operations of both movable and fixed parts.

As described above, by simultaneously collecting the operation sounds of both the movable and fixed parts, the simultaneously collected operation sound data can be compared. Each operation sound collector 4 sends sound data of a collected operation sound to the repeater 3 through the radio interface 44. The repeater 3 simultaneously receives the sound data of the collected operation sounds from the operation sound collectors 4 through the radio interfaces, and stores the sound data (step S111).

The repeater 3 notifies the central management unit 1 of a sound collection operation start. Receiving a notice of the sound collection operation start, the central management unit 1 sends a transfer start command to start transfer (transmission) of sound data to the repeater 3, and starts take-out of the sound data (step S112). Receiving the transfer start command, the repeater 3 reads out stored sound data (step S113), and sends the sound data to the central management unit 1. The central management unit 1 stores received sound data (step S114).

As described above, operation sound data is periodically collected.

FIG. 5 shows a sequence of collecting the operation sound at optional timing according to an operation sound data collection command, in an operation sound collection method using the operation sound collection system according to the embodiment.

The central management unit 1 sends collection start command as an operation sound collection start command to each repeater 3 through the LAN interface 2, and starts collection of the operation sound (step S201). Based on a received collection start command, each repeater 3 establishes radio connection, and sends the collection start command to a managed operation sound collector 4.

The control CPU 41 of each operation sound collector 4 receives the collection start command through the radio interface 44 (step S202), and starts the operation sound collection operation (step S203). The control CPU 41 of each operation sound collector 4 sends a notice of collection start response indicating a sound collection operation start to a managed repeater 3 through the radio interface 44.

Receiving the collection start response, the repeater 3 goes into a collection start waiting state (step S204), and sends (returns) the notice of collection start response indicating the sound collection operation start to the central management unit 1. Receiving the collection start notice, the central management unit 1 goes into the collection start waiting state (step S205).

After starting the collection operation start, the control CPU 41 of each operation sound collector 4 temporarily stores sound data of an operation sound received from the microphone/interface 48 and inclination sensor 101 in the RAM 47, and sends delimiter data obtained from the sound data and inclination angle to the repeater 3 through the radio interface 44 (step S206).

Receiving the operation sound data from the operation sound collector 4, the repeater 3 temporarily stores the data received by the radio interface 37 in the work RAM 35 (step S207). In additionally, the repeater 3 divides data in the work RAM by using a delimiter data code which is simultaneously received with the data, and stores divided data in the data storage ROM 34. After storing the divided data, the repeater 3 informs the central management unit 1 of the end of collection through the LAN interface 32. Receiving the end of collection, the central management unit 1 sends a data sending command to the repeater 3 to start take-out of sound data of the operation sound stored in the repeater 3 (step S208). Receiving the data sending command, the repeater 3 takes out necessary operation sound data from the storage ROM 34 of the repeater 3, and sends data to the central management unit 1 (step S209). Receiving sound data, the central management unit 1 stores the sound data in the HDD 1c (step S210).

Next, an explanation will be given of sending delimiter data from the operation sound collector 4 to the repeater 3 with reference to FIGS. 6 and 7.

Each operation sound collector 4 collects sound data 200 of operation sound of the conveyor 100 and inclination angle data 201. The collected inclination angle data 201 is converted into delimiter data 202 by the control CPU 41 of the operation sound collector 4. For example, as described above, the control CPU 41 of the operation sound collector 4 detects a reverse position based on the inclination angle data 201, determines whether it is a delimiter position, and generates delimiter data 202 indicating the delimiter position when it is a delimiter position (FIG. 13 and so forth). The delimiter data 202 generated by the control COU 41 of the operation sound collector 4 is superimposed on the collected operation sound data 200, and transmission data 203 is generated.

In another embodiment, the collected inclination angle data 201 is converted into delimiter data 202 by the control CPU 41 of the operation sound collector 4. The delimiter data 202 generated by the control CPU 41 of each operation sound collector 4 is assigned to one channel, for example, a right channel of stereo transmission data. The collected sound data 200 is assigned to the other channel, for example, a left channel of the transmission data. The transmission data (stereo data) is sent by using both right and left channels.

A transmitting method of the delimiter data 202 transmitted from each operation sound collector 4 to the repeater 3 is not limited to the embodiment described above. Data may be transmitted from the operation sound collector 4 to the repeater 3 by other methods. By using other methods, it is possible to simplify transmission data and reduce the amount of transmitted data.

In the above explanation of the delimiter data 202, the step of the conveyor 100 is moved from the lower stage to the upper stage on the front side of the conveyor 100, and moved from the upper stage to the lower stage on the back side of the conveyor 100. However, the step movement is not limited to this movement. For example, as shown in FIGS. 13 to 17, the step of the conveyor 100 is moved from the upper stage to the lower stage on the front side of the conveyor 100, and moved from the lower stage to the upper stage on the back side of the conveyor 100.

For example, a delimiter position may be one of positions at which an inclination angle of movable part is corresponds to reference inclination angles of 0°, 90°, 180°, 270°, and 360°. FIG. 13 is a graph diagrammatically showing an example of generating delimiter data by using the inclination sensor 101. The inclination sensor 101 is fixed to the step (the movable part) of the conveyor 100. The delimiter data is generated based on the inclination angle data obtained by the inclination sensor 101. In this case, a position at which the step of the conveyor 100 is reversed in a lower stage is determined to be a delimiter position, and the delimiter data is generated using the inclination angle of 90° as a reference.

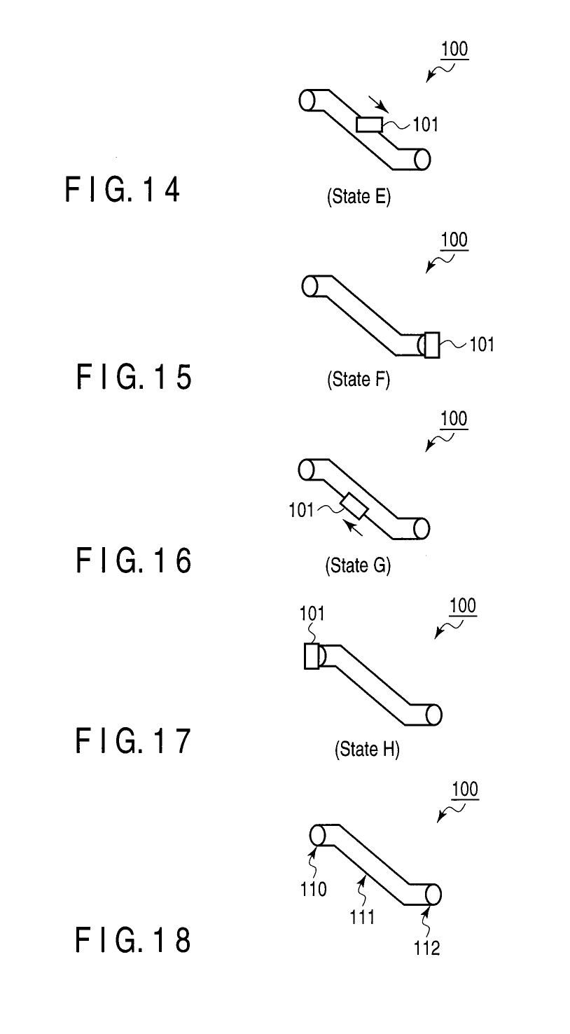

As shown in a state E in FIG. 14, the inclination sensor 101 fixed to the step of the conveyor 100 is moved downward from the upper stage to the lower stage. In this state E, an inclination angle obtained by the inclination sensor 101 is 180° (FIG. 13).

In the state F in FIG. 15, the inclination sensor 101 is moved to and reversed at a position in the lower stage. In this state F, as the inclination sensor 101 is reversed, an inclination angle obtained by the inclination sensor 101 is changed from 180° to 0° and from 0° to 360° (FIG. 13).

Then, in the stage G in FIG. 16, the inclination sensor 101 is moved from the lower stage to the upper stage on the back of the conveyor 100 after reversing. In this state G, an inclination angle obtained by the inclination sensor 101 is 330° (FIG. 13).

In the state H in FIG. 17, the inclination sensor 101 is moved to and reversed at a position on an upper stage. In this state H, as the inclination sensor 101 is reversed, an inclination angle obtained by the inclination sensor 101 is changed from 330° to 360° and from 360° to 180°. Thereafter, the inclination sensor 101 returns to the first state E.

Based on the sound data of the operation sound, and the inclination angle data or delimiter data of the conveyor 100 received from each repeater, the central management unit 1 can identify a part (movable or fixed part) of the conveyor 100 where received sound data is collected. For example, as shown in FIG. 18, an inclination angle is not changed in the microphone/interface 48 and inclination sensor 101 provided in the upper stage 110 and lower stage 112 of the fixed part of the conveyor 100. Therefore, it is possible to determine that sound data is generated in a previously provided fixed part. As an inclination angle of step 111 of the conveyor 100 is cyclically changed, it is possible to identify the position of the movable part in the conveyor 100 where sound data is generated.

Next, the central management unit 1 compares the sound data in the state A with normal sound data in the state A stored in the HDD 1c of the central management unit 1, and determines the sound data is normal when the comparison result is within a threshold value stored in the HDD 1c, and abnormal when the result exceeds the threshold value. For example, when a sound volume is used, an operation sound is determined normal when a threshold value of sound data in the normal state A is 20 to 30 db, and sound data collected in the state A is 25 db, for example, but determined to be abnormal if sound data collected in the state A is 35db, for example. Instead of a sound volume, for example, a sound frequency, or both sound volume and frequency may be used.

Further, in FIG. 18, the operation sound data of the fixed parts 110, 112, and movable part 111 are simultaneously collected. In this case, by comparing the same-time operation sound data of the fixed parts 110, 112 and movable part 111, it is possible to determine whether the parts are normal or abnormal. For example, it is assumed that, at 6:30 on August 7, an operation sound of the fixed part 110 is 25 db, an operation sound of the fixed part 112 is 28 db, an operation sound of the movable part 111 in the state A is 30 db, an operation sound of the movable part 111 in the stage B (close to the fixed part 110) is 34 db, an operation sound of the movable part 111 in the stage C is 29 db, and an operation sound of the movable part 111 in the stage D (close to the fixed part 112) is 41 db, respectively. It is also assumed that a threshold value of an operation sound of the fixed part 110 is 20 to 30 db, a threshold value of an operation sound of the fixed part 112 is 15 to 25 db, a threshold value of an operation sound of the movable part 111 in the state A is 35 db, a threshold value of an operation sound of the movable part 111 in the stage B (close to the fixed part 110) is 30 to 40 db, a threshold value of an operation sound of the movable part 111 in the state C is 25 to 35 db, and a threshold value of an operation sound of the movable part 111 in the stage D (close to the fixed part 112) is 35 to 40 db, respectively.

In this example, the central management unit 1 determines whether a collected sound data is within a respective threshold value or not. In this case, the central management unit 1 determines that an operation sound of the movable part 111 in the state D is 41 db, which is not within a threshold value. The position of the movable part 111 in the stage D is almost the same as the position of the fixed part 112. Further, the sound volume of the sound data for the fixed part 112 collected at 6:30 on August 7 is 28 db, which is not within a threshold value. In this example, the sound data at two positions are abnormal, and a fault can be detected with a high accuracy. As described above, by simultaneously collecting the sound data of movable and fixed parts at the same time, a fault can be determined with a higher accuracy than the case of collecting data at different times. In other words, if the sound data of the movable and fixed parts are collected at different times, the possibility of simultaneously detecting a fault of both the movable and fixed parts is low, and it is impossible to compare the sound data collected at the same time. In contrast, in this embodiment, The sound data of the movable and fixed parts are simultaneously collected, and a fault is determined with a high accuracy.

In this embodiment, a faulty part can be estimated when another movable part which is not the movable part to collect the operation sound data (e.g. a step of a conveyor 100 not collecting the operation sound data) passes through a fixed part at moving time. In a conveyor 100, for example, when an abnormal noise caused by a fault (wearing) occurs in a step other than the step (a movable part) provided with a microphone/interface 48 for collecting the operation sound data, as operation sound data is simultaneously collected from both the movable and fixed parts, it is possible to estimate the noise-generating position in the step included in the conveyor 100 unused to collect the operation sound data, by comparing the sound data. For example, when an operation sound of 35 db (out of a threshold range) is detected in the fixed part 110 at 7:20 on December 10, and an operation sound of the movable part 111 in the stage A or C (at a position at which the step does not reverse) at the same time of day is within a threshold range, the central management unit 1 determines that a fault occurs at the position in the step of the conveyor 100 which passes through on the fixed part 110 at 7:20 on December 10. In identification of a faulty step position, when an operation sound of the movable part 111 in the state A or C is not abnormal at 7:20 on December 10, it is determined that a fault occurs at a position far from the movable part 111. When an operation sound of the movable part 111 in the state A or C at 7:20 is abnormal on December 10, it is determined that a fault occurs at a position close to the movable part 111. As other examples, when a fault caused by a belt or operation chain occurs, even if sound data of the belt or chain itself is not collected, when sound data indicating a fault in a fixed part close to the belt or chain is collected, the belt or chain itself is assumed to be faulty. In the embodiment described above, the conveyor 100 is explained as plant equipment including a cyclically moving part. The moving part is not limited to the conveyor 100. The embodiment is applicable to other plant equipment including the cyclically moving part, such as a conveyor belt.

By using the embodiment, the operation sounds of the plant equipment such as the conveyor 100 can be efficiently collected. By collecting the operation sounds of the plant equipment including the movable and fixed parts, the operation sound data can be collected in a short time, and time to check the fault can be reduced. Further, an abnormal noise can be detected with a high accuracy. Further, based on the delimiter data, the influence of vibration can be reduced without causing age deterioration due to wearing, and the number of cycles of cyclically moving equipment such as the conveyor 100 can be grasped. In this embodiment, it is possible to accurately identify fault occurring in a part which is different from the movable part whose operation sounds are collected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An operation sound collection system collecting operation sounds of equipment, comprising:
a first operation sound collector which is provided in a movable part of the equipment, provided with a first inclination sensor, collects first operation sound data of the movable part, and transmits first data which associates the first operation sound data with first inclination angle data of the movable part or delimiter data indicating a specific position determined based on the first inclination angle data;
a second operation sound collector which is provided in a fixed part of the equipment, collects second operation sound data of the fixed part simultaneously with collection by the first operation sound collector, and transmits second data including the second operation sound data;
a database which stores operation sound data in normal operation;
a receiver which simultaneously receives the first data transmitted from the first operation sound collector and the second data transmitted from the second operation sound collector; and
a controller which determines a first position at which the first operation sound data is collected, based on the first inclination angle data or delimiter data received by the receiver, compares the first operation sound data corresponding to the first position, and the second operation sound data corresponding to a second position indicating the fixed part in which the second operation sound data is collected, with the operation sound data in normal operation stored in the database, and determines whether an operation sound is abnormal.

2. The operation sound collection system according to claim 1, wherein the second operation sound collector is further provided with a second inclination sensor, collects second inclination angle data of the fixed part simultaneously with the collection of operation sound by the first operation sound collector, and transmits the second data further including the second inclination angle data, and
the controller determines the first and second positions, based on the first inclination angle data or delimiter data, and the second inclination angle data, compares the first operation sound data corresponding to the first position with first normal sound data of the normal operation sound data corresponding to the first position, compares the second operation sound data corresponding to the second position with second normal sound operation data of the normal operation sound data corresponding to the second position, and determines whether the operation sound is abnormal.

3. The operation sound collection system according to claim 1, wherein the movable part cyclically moves.

4. The operation sound collection system according to claim 1, wherein the delimiter data indicates at least one of positions determined to be a position at which the movable part is reversed, based on the first inclination angle data, and
the operation sound collection system counts the number of cycles of the movable part, based on the delimiter data.

5. The operation sound collection system according to claim 1, wherein the first operation sound collector sends the first data, in which the delimiter data is superimposed on the first operation sound data, to the receiver by radio.

6. The operation sound collection system according to claim 1, wherein the first data is stereo data, and
the first operation sound collector sends the first inclination data or delimiter data by using a first channel, and sends the first operation sound data by using a second channel.

7. An operation sound collection method executed by an operation sound collection system collecting operation sounds from equipment,
the operation sound collection system comprising:
a first operation sound collector which is provided in a movable part of the equipment, provided with a first inclination sensor, collects first operation sound data of the movable part, and transmits first data which associates the first operation sound data with first inclination angle data of the movable part or delimiter data indicating a specific position determined based on the first inclination angle data;
a second operation sound collector which is provided in a fixed part of the equipment, collects second operation sound data of the fixed part, and transmits second data including the second operation sound data;
a database which stores operation sound data in normal operation;
a receiver which receives the first data transmitted from the first operation sound collector and the second data transmitted from the second operation sound collector; and
a controller which determines whether an operation sound is abnormal, based on the first and second data received by the receiver, and
the operation sound collection method comprising:
collecting the second data by the second operation sound collector simultaneously with collection of the first data by the first operation sound collector,
sending the first and second data simultaneously by the first and operation sound collectors;
receiving the first and second data simultaneously by the receiver;
determining a first position at which the first operation sound data is collected by the controller, based on the first inclination angle data or delimiter data received by the receiver; and
comparing the first operation sound data corresponding to the first position, and the second operation sound data corresponding to a second position indicating the fixed part in which the second operation sound data is collected, with the operation sound data in normal operation stored in the database, and determining whether the operation sound is abnormal, by the controller.

8. The operation sound collection method according to claim 7, wherein the second operation sound collector is further provided with a second inclination sensor, collects second inclination angle data of the fixed part, and transmits the second data further including the second inclination angle data,
the collecting collects the second inclination angle data simultaneously with the collection by the first operation sound collector,
the determining determines the first and second positions based on the first inclination angle data or delimiter data, and the second inclination angle data, and
the determining whether the operation sound is abnormal compares the first operation sound data corresponding to the first position with first normal sound data of the normal operation sound data corresponding to the first position, and compares the second operation sound data corresponding to the second position with second normal sound operation data of the normal operation sound data corresponding to the second position.

9. The operation sound collection method according to claim 7, wherein the movable part cyclically moves.
